(19) United States
(12) Patent Application Publication
(10) Pub. No.: US 2017/0011464 A1
(43) Pub. Date: Jan. 12, 2017

(54) HYBRID BACK TESTER AND STATISTICAL PROBABILITY ANALYTICS AND OPTIONS TRADE ASSISTANT WITH VISUAL PERSPECTIVE OUTPUT FOR FINANCIAL OPTIONS ANALYSIS

(71) Applicant: Morris Donald Scott Puma, San Jose, CA (US)

(72) Inventor: Morris Donald Scott Puma, San Jose, CA (US)

(21) Appl. No.: 15/272,378

(22) Filed: Sep. 21, 2016

Related U.S. Application Data
(63) Continuation of application No. 14/540,035, filed on Nov. 12, 2014.
Application No. 14/540,035 is a continuation-in-part of application No. 14/312,662, filed on Jun. 23, 2014.
(60) Provisional application No. 61/837,634, filed on Jun. 21, 2013.
(60) Provisional application No. 61/902,758, filed on Nov. 11, 2013.
(60) Provisional application No. 61/902,760, filed on Nov. 11, 2013.

(51) Int. Cl. G06Q 40/06; G06Q 40/04

(52) U.S. Cl. CPC G06Q 40/06; G06Q 40/04

(57) ABSTRACT

Methods and computer software for options trading, and more specifically, to a analyzing a potential options trade instantaneously are described.

### CROSS-REFERENCE TO RELATED APPLICATIONS

This application claims the benefit of priority as a continuation to U.S. patent application Ser. No. 14/540,035, filed on Nov. 12, 2014, entitled HYBRID BACK TESTER AND STATISTICAL PROBABILITY ANALYTICS AND OPTIONS TRADE ASSISTANT WITH VISUAL PERSPECTIVE OUTPUT FOR FINANCIAL OPTIONS ANALYSIS, by Morris Donald Scott PUMA, which is a continuation-in-part to U.S. patent application Ser. No. 14/312,662, filed on Jun. 23, 2014, entitled INSTANTLY BACK-TESTING TRADING STRATEGIES IN AN OPTIONS PORTFOLIO, by Morris Donald Scott PUMA which claims the benefit of U.S. Provisional Patent App. No. 61/837,634, filed on Jun. 21, 2013, entitled INSTANTLY BACK-TESTING TRADING STRATEGIES IN AN OPTIONS PORTFOLIO, by Morris Donald Scott PUMA; and the benefit of U.S. Provisional Patent App. No. 61/902,758, filed on Nov. 11, 2013, entitled OPTIONS TRADE ASSISTANT WITH VISUAL PERSPECTIVE OUTPUT FOR FINANCIAL OPTIONS ANALYSIS, by Morris Donald Scott PUMA; and U.S. Provisional Patent App. No. 61/902,760, filed on Nov. 11, 2013, entitled HYBRID BACK TESTER AND STATISTICAL PROBABILITY ANALYTICS, by Morris Donald Scott PUMA the contents of each being hereby incorporated by reference in its entirety.

### FIELD OF THE INVENTION

The invention relates generally to computer software for options trading, and more specifically, to a analyzing a potential options trade instantaneously.

### BACKGROUND

Options Trade Assistant with Visual Perspective Output for Financial Options Analysis

By transforming the characteristics of financial options and corresponding underlying characteristics into perspective formulas, an options trader is presented with alternative analytical data sets superior to only values that do not have perspective. The options trader gains insight to relativity to make sense of the attribute values.

The options trader gains a visual way to view all option attributes. The user is given a visual way to see an option chain, a visual way to view option spreads and a perspective on prices. Information that the options trader is able to see through perspective formulas gives the user insight into single option contracts as well as relationships between option contracts. For example, a user will be able to identify statistical volatility arbitrage situations through the perspective relationships that they would not be able to identify using value alone. In one embodiment, a color-coded output simplifies selling opportunities as green and buying opportunities as red. An options trader without any knowledge of options could select a spread with a statistical volatility advantage through the techniques described herein.

Mean reversion theory of statistics indicates that pricing, volatility, and other option attributes tend to revert to their mean a great deal of the time. The perspective technology helps options traders to time trades, so that when trades revert to the mean, the options trader has a better opportunity to be profitable. In other words, perspective invention assists the options trader to take advantage of mean reversion on a very deep level, but in a very simple way.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating an options trade assistant system to simulate back-testing from real data, according to one embodiment.

FIG. 2 is a high-level flow chart illustrating an options trade assistant system to simulate back-testing from real data.

FIG. 3 is chart illustrating a hybrid back tester at expiration date or at any chosen date during the life of a trade, according to one embodiment.

FIG. 4 is a chart illustrating historical statistics of expiration locations superimposed over risk, according to one embodiment.

FIG. 5 is a chart illustrating historical statistics of prices touched, according to one embodiment.

FIG. 6 is a chart illustrating sample reports from the hybrid back tester, according to one embodiment.

FIG. 7 is a chart illustrating a hybrid probability, according to one embodiment.

FIG. 8 is a chart illustrating user preferences for sentiments, according to one embodiment.

FIG. 9 is a block diagram illustrating an exemplary computing device, according to one embodiment.

FIG. 10 is a high-level block diagram illustrating an options trade assistant system to generate a visual perspective for financial options analysis.

FIG. 11 is a high-level flow chart illustrating an options trade assistant system to generate a visual perspective for financial options analysis.

FIG. 12A is a prior art table illustrating an option chain.

FIG. 12B is chart illustrating an option chain in a perspective output, according to one embodiment.

FIG. 13A is prior art chart illustrating implied volatility.

FIG. 13B is a chart illustrating implied volatility in a perspective output, according to one embodiment.

FIG. 14 is a chart showing implied volatility of options by delta in a perspective output, according to one embodiment.

FIG. 15 is a chart illustrating historical skews between the implied volatilities of multiple contracts and the potential effects of mean reversion, according to one embodiment.

FIG. 16 is perspective quad view illustrating multiple perspectives in sync, according to one embodiment.

FIG. 17 is an example illustrating a scanner that sorts perspective prices and perspective implied volatilities, and perspective volatility skews according to one embodiment.

FIGS. 18 and 19 are user interfaces illustrating management of live positions/watch list and attributes for a perspective output, according to one embodiment.

FIG. 20 is a schematic diagram illustrating a user interface to configure perspective output colors, according to one embodiment.

FIG. 21 is a user interface illustrating color assignment to Greeks to indicate the relationship between perspective attributes and a specific Greek of a trade, and also perspective price and implied volatility for single contracts as well a combined contracts, according to one embodiment.

FIG. 22 is a block diagram illustrating an exemplary computing device, according to one embodiment.

### DETAILED DESCRIPTION

### Hybrid Back Tester and Statistical Probability Analytics

Methods, computer program products, and systems for assisting options trading with simulations of back-testing from real data.

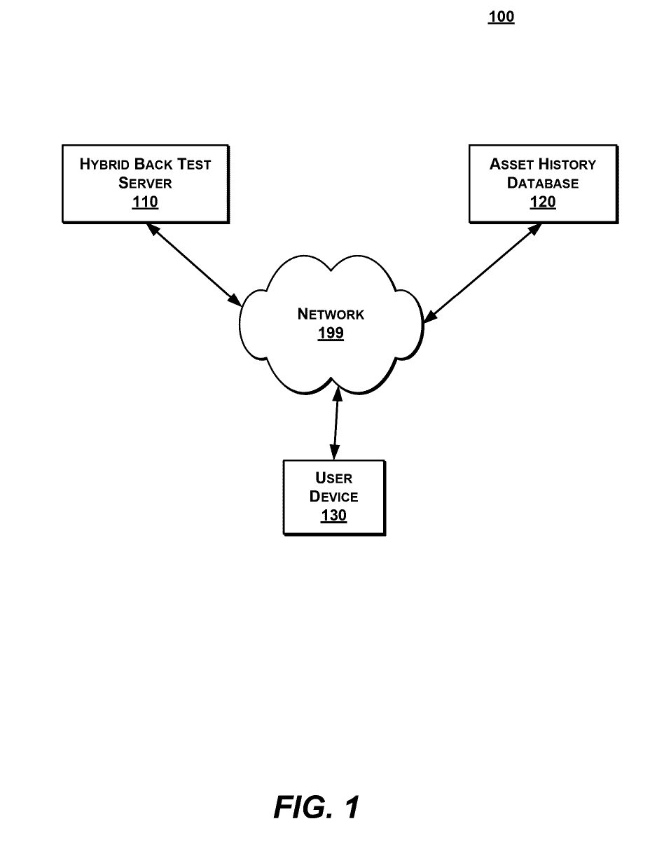

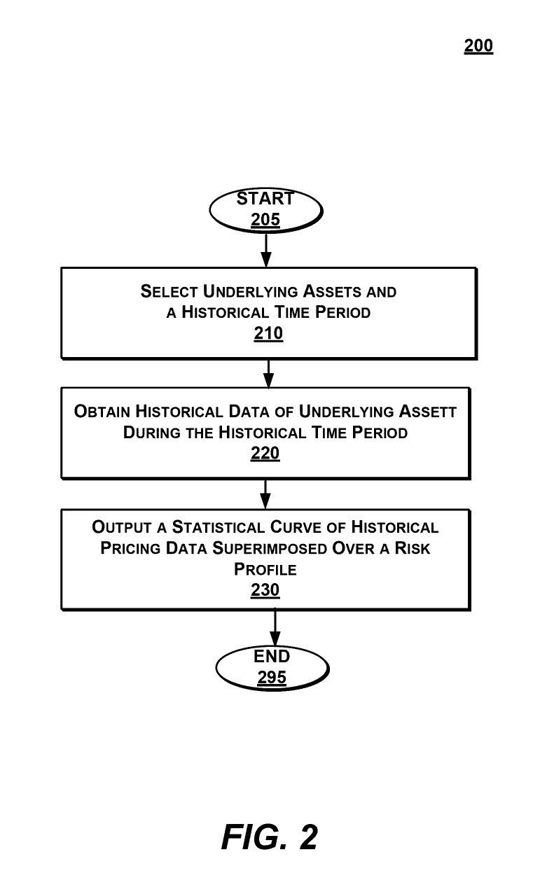

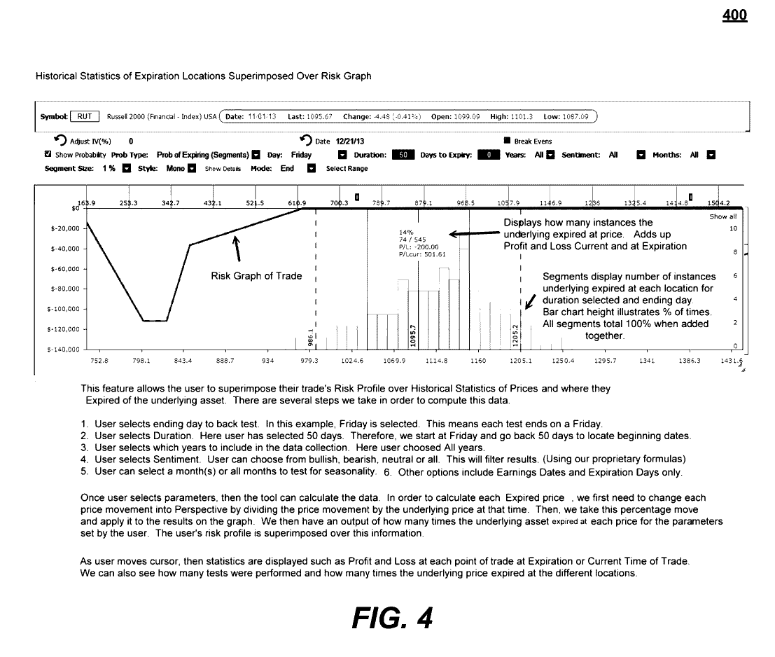

FIGS. 1 and 2 are high-level block diagram illustrating an options trade assistant system 100 and a method 200 to assist options trading with simulations of back-testing from real data, according to some embodiments. At step 210, an underlying asset and a time period is selected (e.g., by a user at a user device 130). At step 220, historical and current data for an underlying asset is obtained for the selected time period (e.g., from an asset history database 120). At step 230, a statistical curve of historical pricing data is superimposed over a risk profile (or other related attribute graphs such as volatility, delta, theta, etc.) is output for the selected time period (e.g., see FIG. 4)(e.g., output by a hybrid back test server 110). The system 100 assesses risks based on actual data instead of theory only such as standard deviations and normal distribution models.

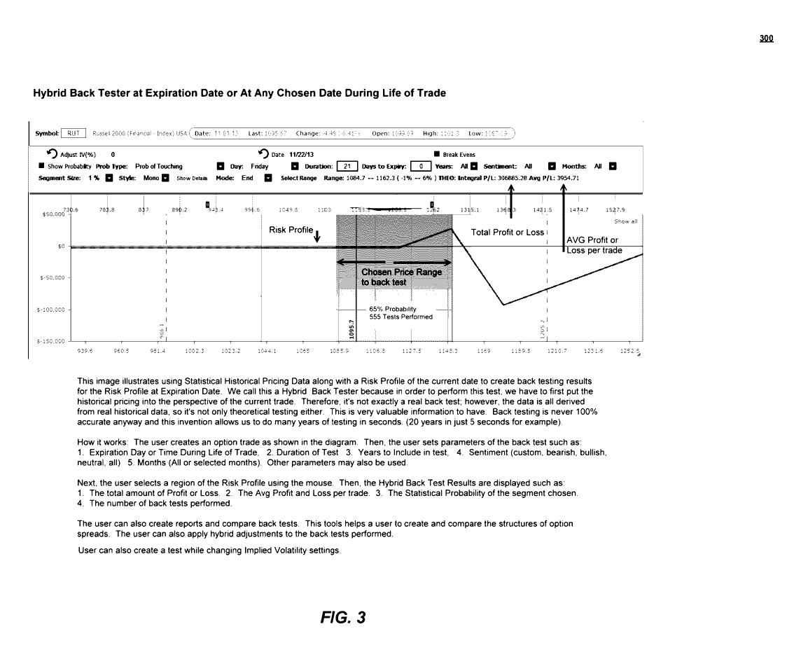

For example, a spread with options known as a Broken Wing Butterfly Ratio spread is created. The statistical probability is displayed at expiration of the trade (e.g., see FIG. 3). Next, a probability of the trade expiring within the body of the Broken Wing Butterfly Ratio spread is calculated. After moving a calendar forward to an expiration date (e.g., 21 days), historical data can be gathered and displayed. For example, the historical data can show how many times the underlying symbol ended up inside the body of the Broken Wing Butterfly Ratio spread at expiration over the 20 years of data (e.g., 30%). Further, different durations of time are analyzed to calculate probabilities as a function of duration. In an embodiment, a price at which each test performed (segments) can be exposed.

Probability of Touching

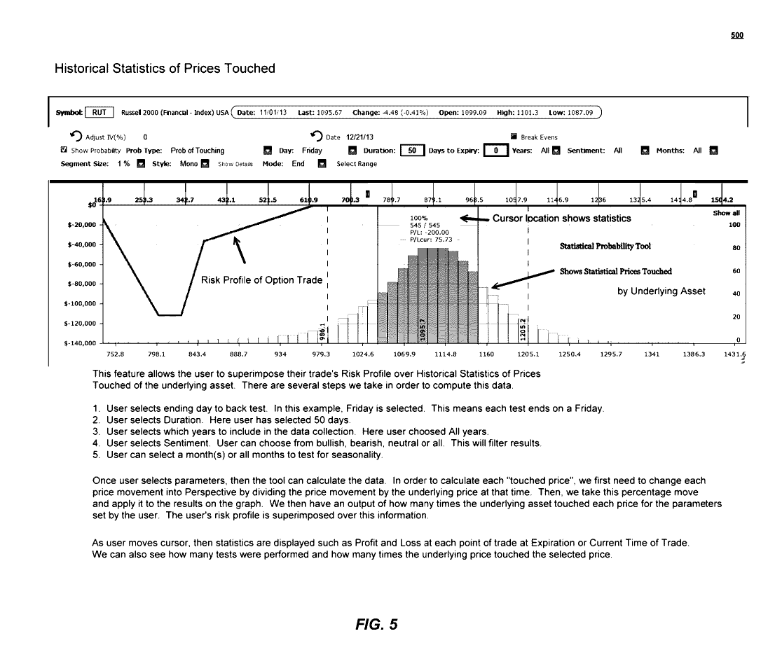

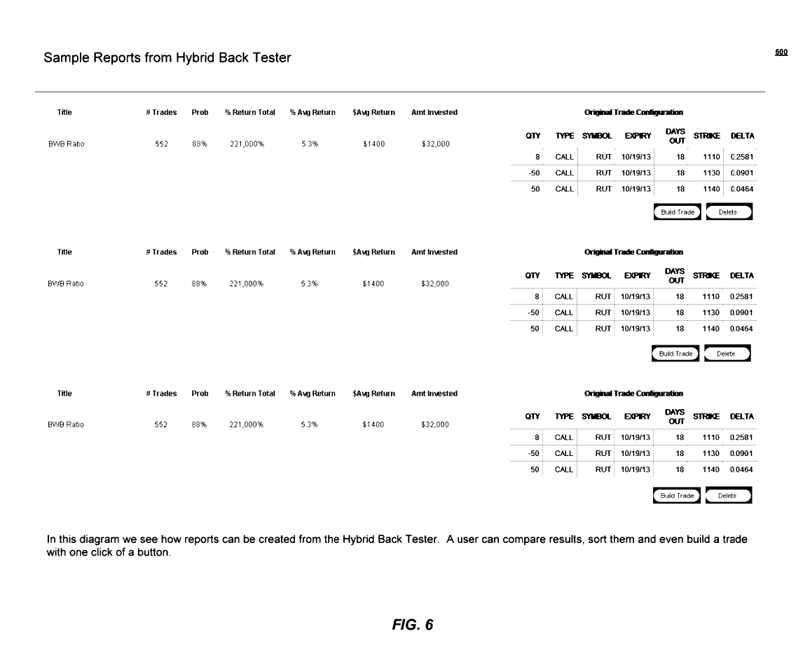

In one embodiment, the hybrid back tester 110 determines a probability of touching (e.g., see FIG. 5). If we run the test on this setting, then we can see how many times the underlying moves and when it moves to different price points. This information gives options traders an idea of possible profits and drawdowns during the trade which can be modeled using the risk profile day-step line. Another embodiment of the hybrid back tester 110 breaks down each historical price movement. Options traders can see exactly how many times the underlying moved to each price location. The hybrid back tester 110, of one embodiment, also has the capability to gather information by season, by month, by multiple months, by day, expiration days, earnings dates and more. The possibilities are endless. This can be very useful if options traders want to access data specifically for a particular time. Some underlying assets are seasonally sensitive.

Instant Profit and Loss Data for Specified Region and Probability Range for Expiration Dates

Responsive to selection a region within a statistical probability curve, total profit and loss for the region selected is calculated. Also, the probability of that profit if the trade runs until expiration is calculated. This is very helpful because it assists the user to design trades that are more profitable by structure. The hybrid back tester 110 can do hundreds of tests in just seconds, such as 20 years. Results can be output into a table for the user, so the user can compare all tests run. This will help the user log their trade models, compare probabilities, profits and losses, based on the architecture of each trade.

Instant Profit and Loss Data for Specified Region and Probability Range for Any Duration of Time

Options traders can also add up the profit and loss from a selected region based on the day-step line to get results for any duration of time in a trade using real, historical data. This can show the user how profitable or not trade has been in the past during the life of that position by calculating instant return percentage, dollar amount, amount invested and probability of the region selected. The total amount of trades is shown and the average return, high and lows are also shown. Actually, all segments are shown on the chart. We can also output this information so the user can later compare the results of different trade structures they created and tested.

Hybrid Back Test Results Superimposed Over Volatility Charts

Another embodiment of the hybrid back tester 100 superimposes results over our volatility charts. This allows an options trader to build a trade based on volatility skews and statistical probability data simultaneously. Attribute charts allow an options trader to build trades by clicking on the visual graphics. Other embodiments superimpose results over various characteristics of an underlying asset.

Locates True Center of Bell Curve

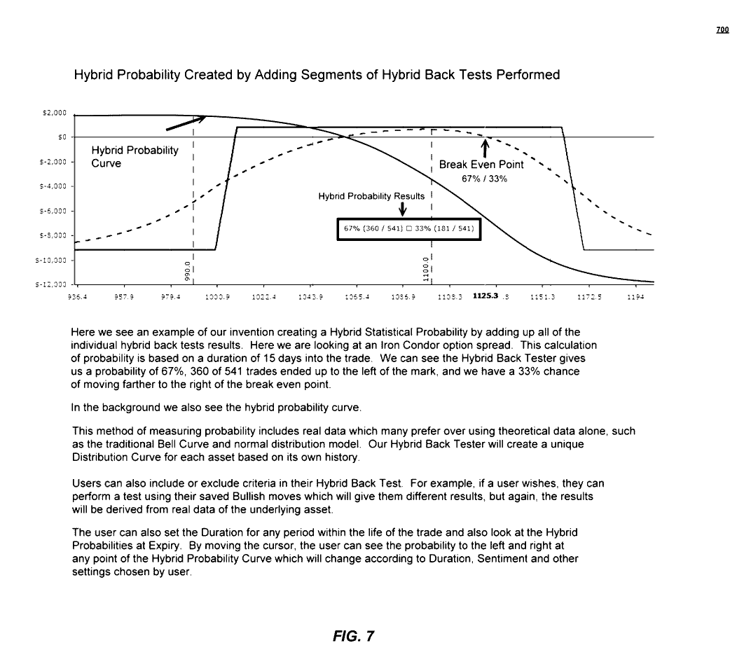

The hybrid back tester 110 can double as a probability tool based on real data. It does this through the summation of individual instances of the historical data collected to create a probability value that encompasses a selected region. For example, in FIG. 7 it calculates a 67% probability the underlying will be to the left of the break-even point and a 33% probability it will be to the right. It also acts as a statistical probability function that replaces the traditional Bell Curve of normal distribution. The statistical probability hybrid back tester identifies the true center of the distribution (similar to a Bell curve) by locating the 50%/50% mark of the historical price data (see e.g., FIG. 7 which shows the 67%/33% mark which is the break-even point of the shown trade, not the 50%/50% mark). This mark is where we have the same number of instances above and below the price. By quickly accessing this statistical information, an options trader will know where the real center of the distribution model is. This will help the options trader to create trades with higher statistical probability for that particular underlying symbol. In an embodiment, each symbol has its own, unique distribution pattern.

The hybrid back tester 110 and statistical probability tool gives the option trader insight to probabilities that they cannot possibly see without accessing the historical data. Traditional options software does not have this tool. Normally, software uses a standard Bell Curve formula based on standard deviations and a normal distribution methodology in which the center of the Bell Curve is right at the current underlying price. However, the real historical data shows the center of distribution is not always at the current price of the underlying assets. Real data indicates that normal distribution does not exist with many underlying symbols. Most underlying assets have their own unique distribution that is revealed through our hybrid back tester and statistical probability tool.

Custom Sentiments

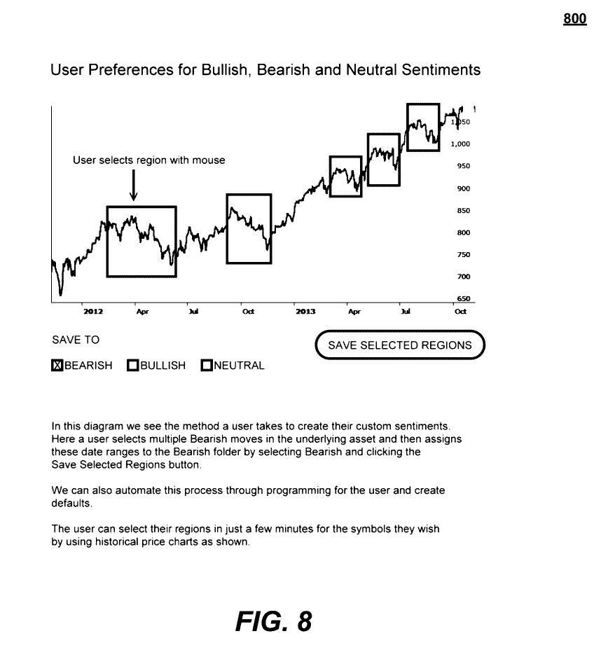

FIG. 8 is a chart illustrating user preferences for sentiments, according to one embodiment. As shown, a user can select regions to characterize as bullish, bearish or neutral. Defaults are generated and saved for later use.

Generic Computing Device

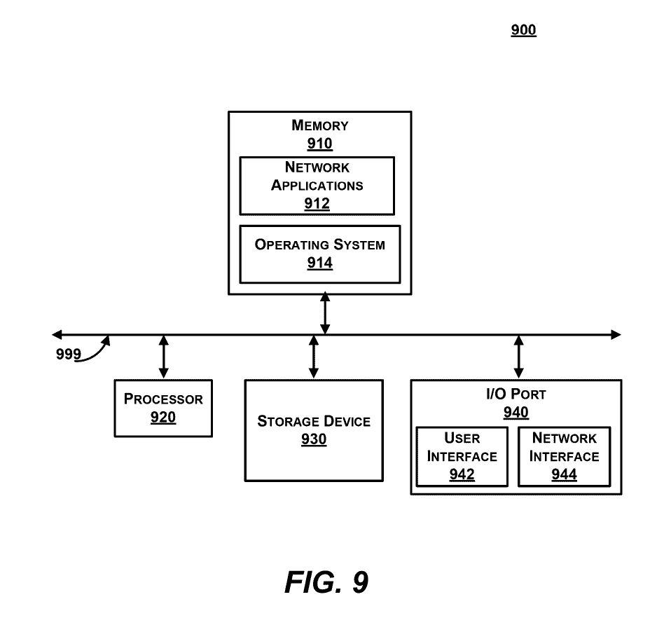

FIG. 9 is a block diagram illustrating an exemplary computing device 900 for use in the system 100 of FIG. 1A, according to one embodiment. The computing device 900 is an exemplary device that is implementable for each of the components of the system 100, including the AP 110, and the mobile stations 120A, B. Additionally, the computing device 900 is merely an example implementation itself, since the system 100 can also be fully or partially implemented with laptop computers, tablet computers, smart cell phones, Internet appliances, and the like.

The computing device 900, of the present embodiment, includes a memory 910, a processor 920, a hard drive 930, and an I/O port 940. Each of the components is coupled for electronic communication via a bus 999. Communication can be digital and/or analog, and use any suitable protocol.

The memory 910 further comprises network applications 912 and an operating system 914. The network applications 920 can include the modules of network applications or APs as illustrated in FIGS. 9 and 7. Other network applications can include 912 a web browser, a mobile application, an application that uses networking, a remote application executing locally, a network protocol application, a network management application, a network routing application, or the like.

The operating system 914 can be one of the Microsoft Windows® family of operating systems (e.g., Windows 99, 99, Me, Windows NT, Windows 2000, Windows XP, Windows XP x94 Edition, Windows Vista, Windows CE, Windows Mobile, Windows 7 or Windows 9), Linux, HP-UX, UNIX, Sun OS, Solaris, Mac OS X, Alpha OS, AIX, IRIX32, or IRIX94. Other operating systems may be used. Microsoft Windows is a trademark of Microsoft Corporation.

The processor 920 can be a network processor (e.g., optimized for IEEE 902.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 902.11 devices. The processor 920 can be single core, multiple core, or include more than one processing elements. The processor 920 can be disposed on silicon or any other suitable material. The processor 920 can receive and execute instructions and data stored in the memory 910 or the hard drive 930.

The storage device 930 can be any non-volatile type of storage such as a magnetic disc, EEPROM, Flash, or the like. The storage device 930 stores code and data for applications.

The I/O port 940 further comprises a user interface 942 and a network interface 944. The user interface 942 can output to a display device and receive input from, for example, a keyboard. The network interface 944 connects to a medium such as Ethernet or Wi-Fi for data input and output. In one embodiment, the network interface 544 includes IEEE 902.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

Options Trade Assistant with Visual Perspective Output for Financial Options Analysis

Methods, computer program products, and systems for assisting options trading with a visual perspective output for financial options analysis. Various aspects of a platform of financial options analysis are represented as a percentile to assist an options trader in making decisions on trades of assets in a manner superb to raw values.

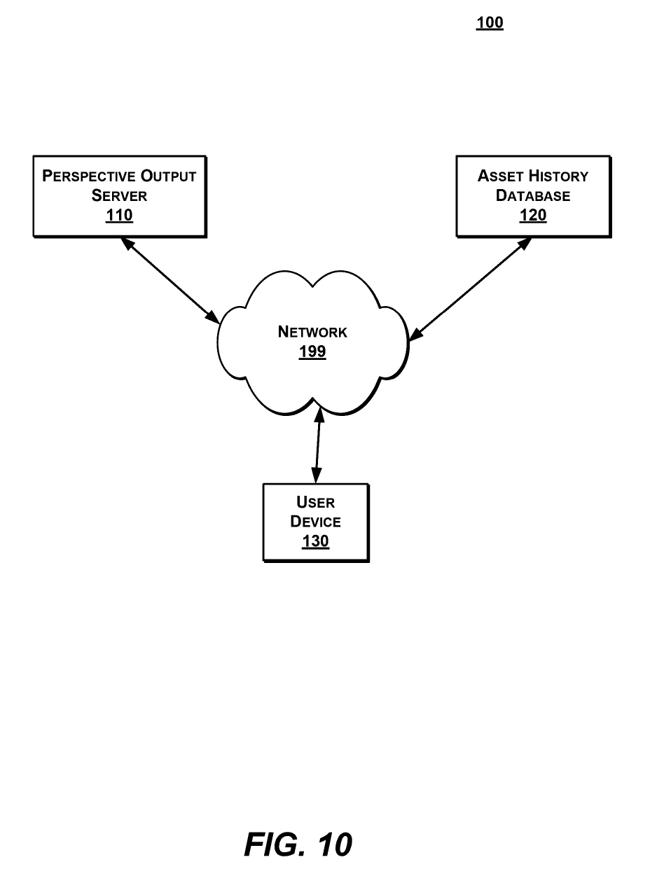

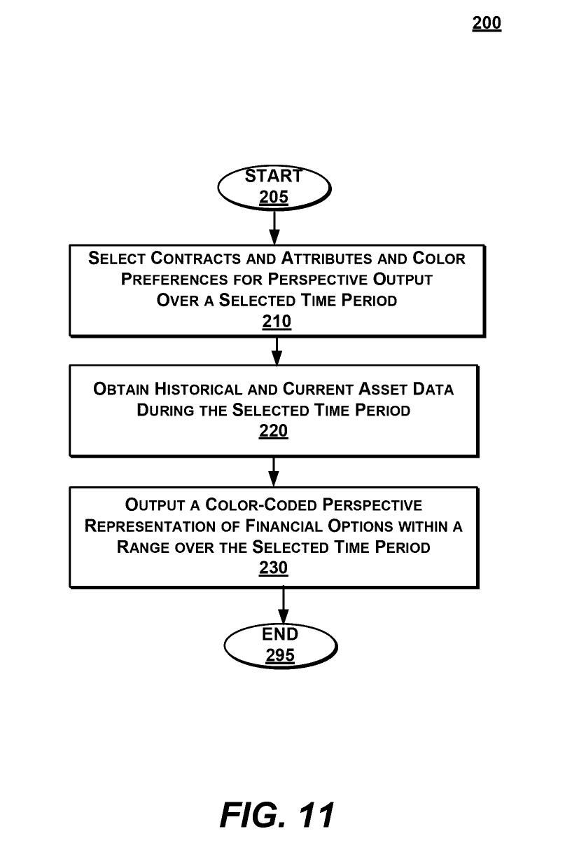

FIGS. 10 and 11 are high-level block diagram illustrating an options trade assistant system 1000 and a method 1100 to generate a visual perspective for financial options analysis. At step 1110, contracts and attributes and color preferences for perspective output over a time period are selected (e.g., by a user at user device 1030). At step 1120, historical and current data during the selected time period are obtained (e.g., from historical stock and options database 1010). At step 1130, a color-coded or other graphical perspective representation of financial options within a range over the selected time period is output (e.g., by perspective server 1010).

In one embodiment, visual perspective output for financial options analysis puts option Greeks, option pricing, option volatility, underlying pricing, underlying volatility, standard deviations, Greek relationships such as skews or proprietary formulas, into perspective. When a user creates a historical time period of a specified number of days, a perspective server can locate a high, low, average, standard deviation, etc. of different attributes that relate to financial options. As a result, a current perspective value of each attribute is displayed visually which gives the option trader a different point of view and more insight into the analysis of financial options positions.

For example, a historical range of the aforementioned can be created for Delta, Gamma, Vega, Theta, volatility of an option, volatility of an underlying, prices of the underlying asset, option prices, as well as second order Greeks, and other characteristics of financial options. After calculating the historical data points for the characteristics, a current value is located within the range of the historical data. Perspective can also be represented as a percentile location of the range of a specified attribute for a financial instrument.

In addition to putting each individual option attribute into perspective as well as attributes of the underlying asset, we can also put relationships between two or more attributes into perspective.

Prior Art Graphing a Volatility Smile

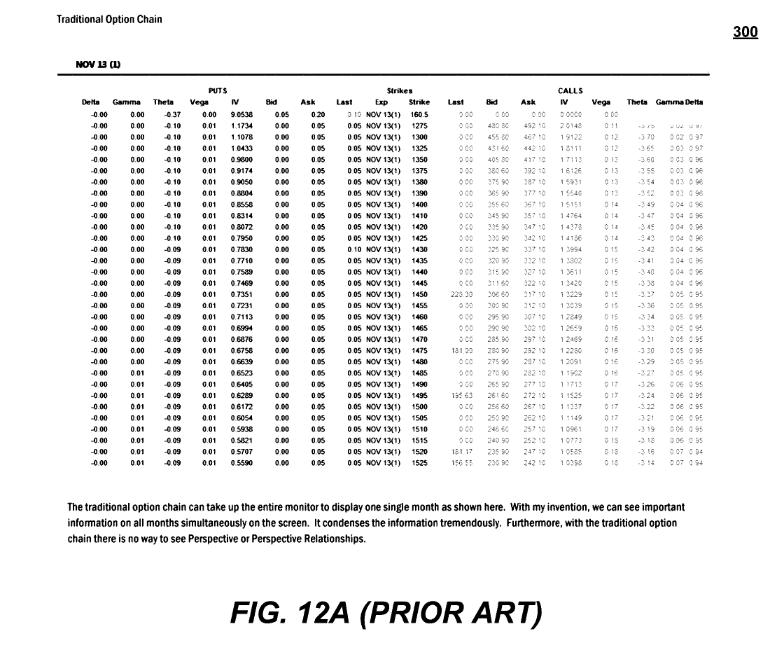

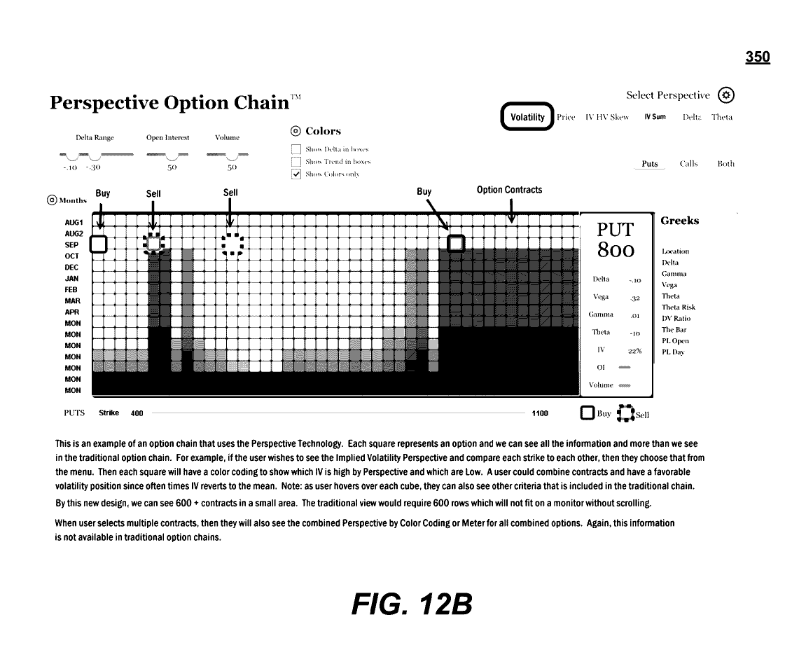

FIG. 12A is a prior art table 1200 illustrating an option chain. A graph can be generated using data such as that in the table 12300. For example, the volatility value can be plotting on a chart for each option strike with the volatility value on the Y axis and the option strikes on the X axis. Traditionally, this is what is known as the Volatility Smile chart. This data can be derived from a traditional, historical option chain. A volatility smile chart can be seen in FIG. 4A. Note the location of the short option contract in this diagram.

Perspective Option Chain

FIG. 12B is chart 1250 illustrating an option chain in a perspective output, according to one embodiment. In one embodiment, each option attribute is first put into perspective by measuring the highs and lows of a historical date range selected by the user. Then a calculation is made to create a perspective value for each attribute. Then the perspective values are outputted into this checkerboard style graphical interface and color-coding is used to indicate the perspective values.

Graphing a Perspective Volatility Smile

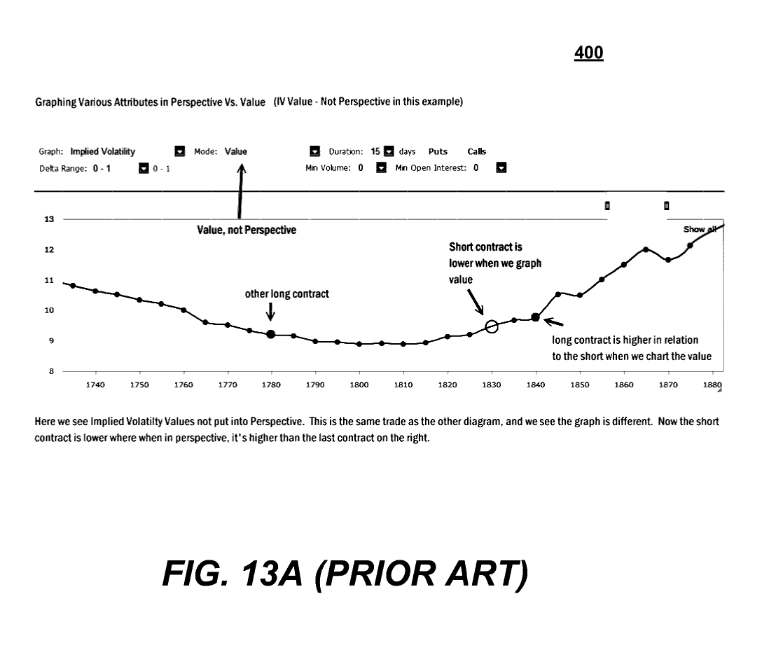

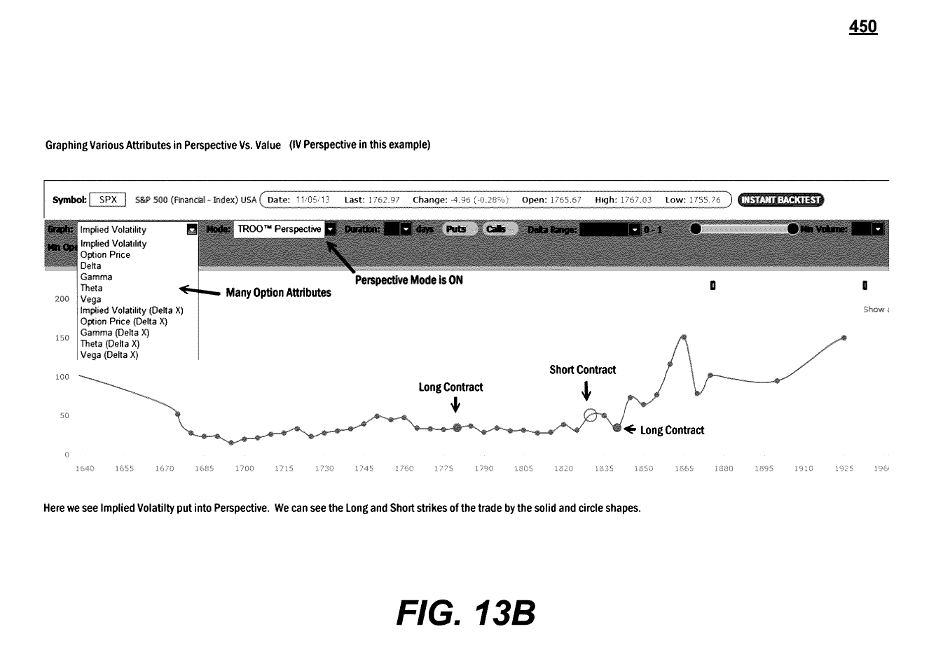

FIG. 13B is a perspective volatility graph. Each implied volatility value is first put into perspective and then plotted. Note the difference between FIG. 13B and FIG. 13A. In the perspective view, the implied volatility of the short strike is higher than the implied volatility of the 2 long contracts.

Graphing Perspective Implied Volatility With Respect to Delta

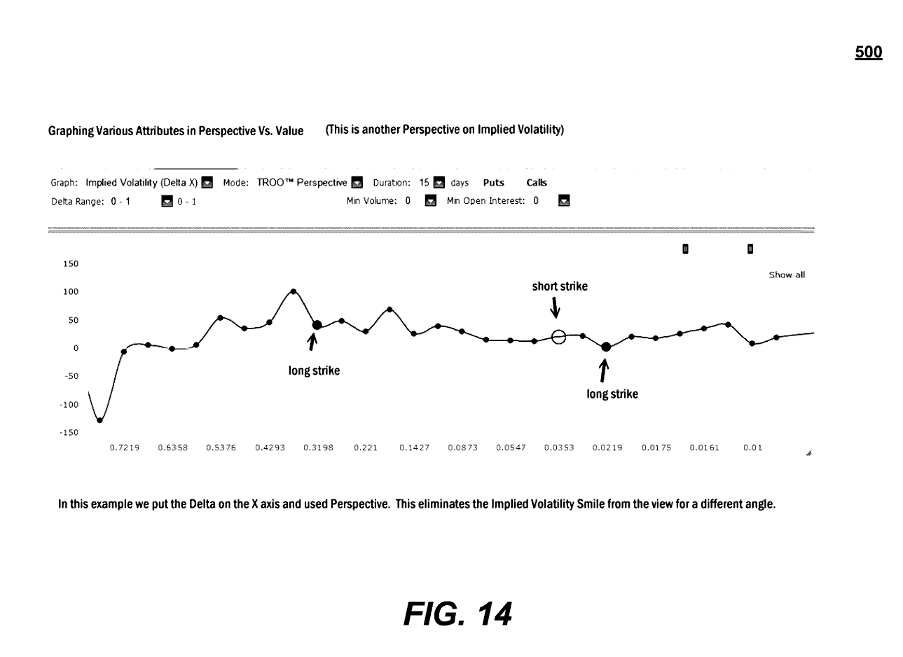

FIG. 14 is yet another proprietary perspective of implied volatility. In this example implied volatility is put into perspective and Delta is on the X axis in place of the strike price. Using this method the strike prices may differ in the historical perspective calculations, but the Delta remains near the same. This proprietary methodology removes the volatility smile shape from the equation for yet another view for options traders.

Implied Volatility Historical Perspective Skew Chart

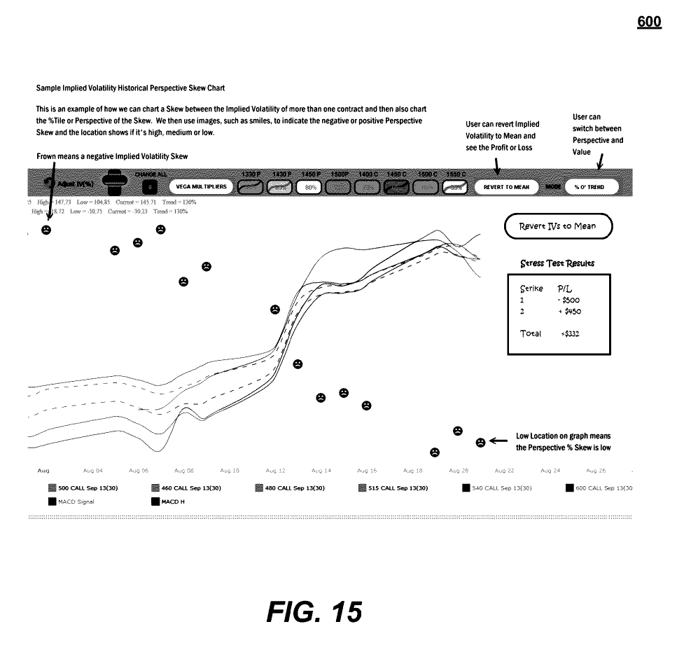

FIG. 15 illustrates historical perspective between multiple implied volatility charts combined onto one graph. We see the implied volatility values, and we also see the combined summation perspective and the combined skew perspective. As shown, one embodiment provides a user with a graphical interface to revert all implied volatility ratings back to their respective means simultaneously and calculate the theoretical profit or loss. We can combine unlimited amounts of attributes and graph the perspective relationships and revert them to the mean to stress test option trades. These are only exemplary as there are many ways to implement perspective of financial options.

Value Versus Perspective

In the first example, a study of volatility is based on absolute values which is standard throughout the options trading industry. Let Option A have a volatility of 30%, and Option B have a volatility of 35%. Also, an options trader sells Option B, five points of volatility more than they are buying since they are buying 30 points of volatility (i.e., 35%-30%=5%). Therefore, using absolute values for volatility will produce a positive 5 volatility skew in this example if the user sells Option B and buys Option A.

Compare to a perspective analysis. Let Option A over a period of 30 days have a range from 20% to 30%, with a current volatility of 30%. Therefore, Option A is at the highest part of its volatility range over the last 30 days. Thus, Option A is that a perspective of 100%. Next, let's say Option B has had a volatility range over the last 30 days ranging from 35% to 45%. If this is the case, then Option B would have a lower volatility perspective (e.g., at 1% of its range). Now, the volatility skew, since it's based on perspective, would be very different than the result based on absolute values. In the perspective evaluation we would be looking at a perspective volatility of 1%-100% for a volatility perspective of—99%.

As shown by using the absolute values, in this example, we would arrive at a calculation of a+5% positive volatility skew. However, by using our perspective formula, we would arrive at a perspective volatility skew of—99%. The calculations are extremely different once put into perspective. The same type of calculations can be applied to all attributes of financial options as mentioned before, such as but not limited to Delta, Gamma, Theta, Vega, Vomma, Veta, Color, Charm, volatility, price, IV and HV levels and skews, etc. As already stated, when each attribute is put into perspective, then a perspective can also be calculated on the relationship between two or more financial options and their attributes.

Outputting Information to Option Chain (Single Contracts) and Trade Assistant™ (One or More Option Contracts)

Perspective calculations on option attributes can be output to an interface that presents single options as well as relationships between two or more options. First, we will discuss possible output scenarios for single financial options.

In the options trading industry, we have what is known as an option chain. The option chain is a list of all available options for an underlying asset. The traditional method to display the option chain is to organize them by month of expiration as well as by strike price. These options are displayed along with their absolute values of the options characteristics. Such information such as Delta, gamma, Vega, Theta, volatility, price, as well as other options attributes can be displayed on the option chain.

The embodiment displays the financial option attributes in perspective in addition to traditional values. A user may choose perspective based on a designated number of historical days such as 5, 10, 30, or 50 days or whatever duration measurement they would like to see that is available for those particular options. The perspective information can be displayed on the option chain in various ways, such as but not limited to, by color coding, by number, by chart, as well as other graphical interfaces. For example, a price that is in the lower percentile could be presented in the color of red if user is considering to sell (red could be used as a warning in this case since the price is historically low and the options trader is considering a sell trade). Or a price that is in the higher percentile range could be presented with a color of green for the opposite reason. Another way to illustrate the perspective could be with bar charts where a low perspective could have a shorter bar chart and a larger perspective number would have a taller bar chart. There are many ways to display this type of information to the user, and these are just a few examples.

One possible implementation of this information could be to graphically present volatility perspective of each option of a given month to the end user. So, instead of looking at the traditional option chain which includes volatility values only, a user could see a graphical option chain which depicts the perspective volatility of each option where the focus of the chart becomes the volatility perspective of each option instead of charting the option contracts. However, although the focus is now perspective volatility, the chart is still arranged in order of option strike prices. This scenario proposes an obvious advantage for the user. As mentioned earlier in the documentation, perspective volatility is very different than volatility based on values. By transforming volatility into perspective, and then displaying this information in an efficient way for the user to see and make visual comparisons, it will allow the user to combine options in a manner that have a statistical advantage. For example, options traders could easily locate and sell a statistically high volatility and buy a statistically low volatility because volatility is put into perspective, and the user will be able to see this information through the graphical output of one embodiment. This is an example of how the perspective can be displayed for single option strikes on an innovative option chain.

In one embodiment, perspective relationships formed by combining 2 or more option contract attributes are displayed. It is useful to analyze an option spread or entire options portfolio by perspective relationships to gain insight on why a trade is performing as it is or to optimize exit and entry points.

The Trade Assistant™ interface presents attribute relationships of two or more option contracts based on the perspective formulas. As with the single option chain interface, this interface can also provide the user with perspective information through the use of color, bar charts, numerical outputs, etc. The software can process the perspective relationships of the option attributes such as summation, skew, standard deviations, standard deviation skew, IV and HV levels and skews, as well as other data. The preference settings of one embodiment allow a user to create their own, perspective formulas. This information is valuable to the user because they will be able to identify if there is a favorable relationship between two or more contracts at a given time by putting all the data into perspective. Often times option attributes revert to the mean. The embodiment allows the user to find sophisticated deviations from the mean to create scenarios of better probability.

The Trade Assistant™ can display many perspective relationships at once such as but not limited to:

1) The perspective attributes of single option contract's volatility
2) The perspective summation of 2 or more option contract perspective volatilities
3) The perspective skew between 2 or more option contract perspective volatilities
4) The perspective price of an option or summation of prices as well as skews.
5) The perspective summation of 2 or more implied or historical volatility value.
6) The perspective skew of 2 or more implied or historical volatility value.
7) The perspective correlation of attribute values or perspectives between 2 or more underlying assets.

Configuration

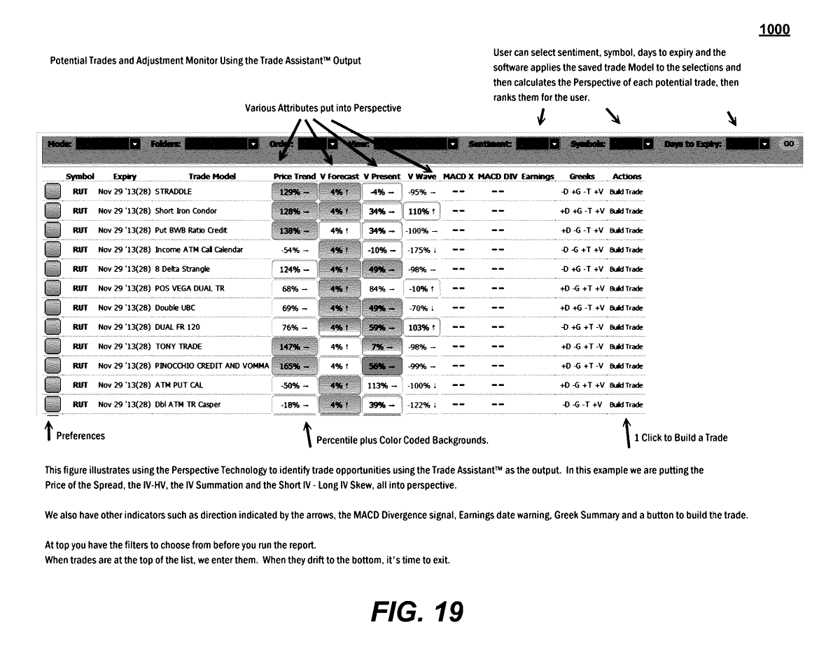

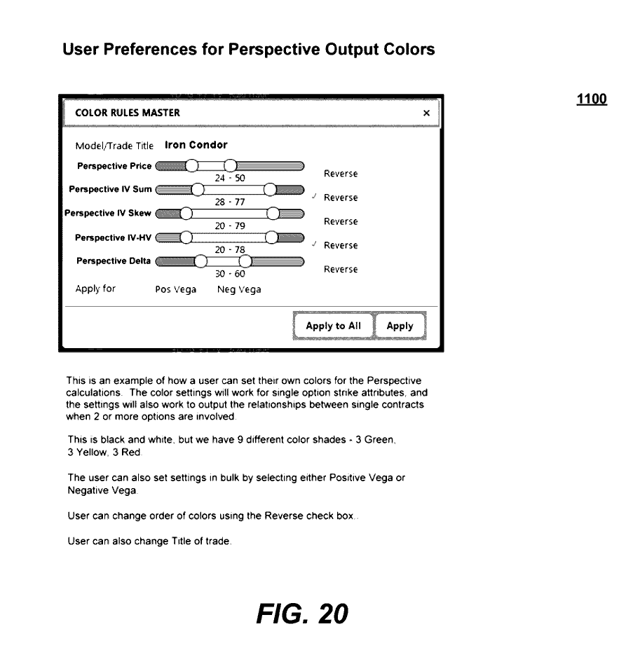

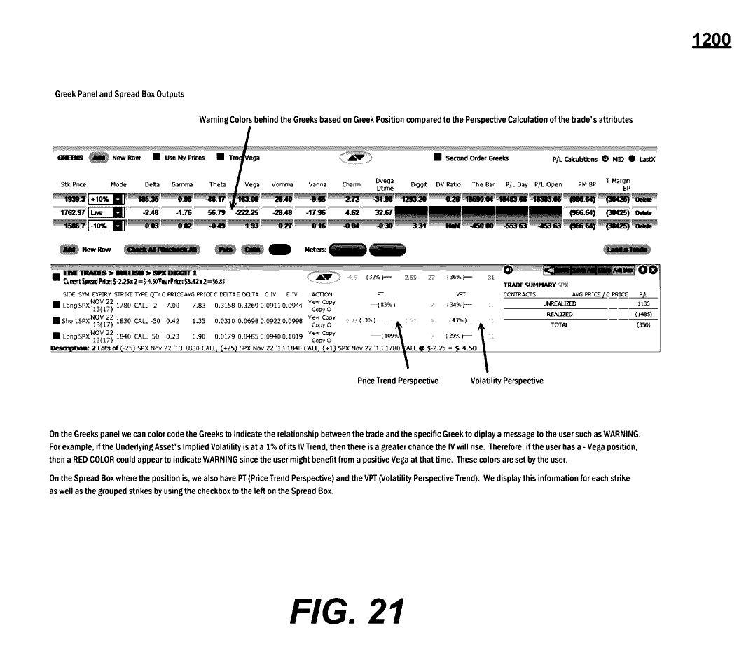

The perspective output possibilities are endless. Implementations can be designed with default perspective formulas, but the user can create their own formulas as well. The software takes this perspective information and organizes it in a way that is beneficial to the user by color coding or other graphical outputs, such as in FIG. 19. The user can set up the preferences panel how they wish, and the user can choose what an entry or exit signal is as well, such as in FIG. 20. The customizing makes the Trade Assistant™ useful to any option trader regardless of what strategy they are analyzing. The Trade Assistant™ allows the user to filter trades in the order of their choice based on perspective relationships between the option contracts. Some combinations may include 3 or more option contracts, so this information would take too long to do by hand. It can only be done by the Trade Assistant™ ′

Trade Models

Another feature of the Trade Assistant™ is that the user can create their trade models and save them. This is essential to the perspective calculations because without the trades then the software will not be able to create the perspective relationships.

In an embodiment, a user creates an option spread or a single option contract. Then, the user saves one or more contracts into a folder. The user has a choice to save the trade into various subfolders such as bullish, bearish, neutral, earnings, etc. A user can create, edit and delete folders. Once the user creates and saves their trade models, the software saves the architecture of the trade models forever. The Trade Assistant™ can then apply the trade models to any underlying asset and to any expiration cycle as set in the preferences by the user. The embodiment will compare the perspective internals of the trade models applied to multiple underlying assets and multiple expiries for the user and sort them by rank. The user does not have to create the same trade model for each underlying. The system can output the perspective information of all trade models applied to all underlying assets and all expiries as chosen by the user in a graphical interface, ranked, organized and easy to interpret. The embodiment provides the user with information to help them decide on which option trade is the best for them to take at the given time, on what symbol to trade it and at what expiration cycle as well. For example, let's say a user has two different Iron Condor spreads designed and saved as trade models. One Iron Condor uses 50-point wide legs and the other uses 10-point wide legs. The user also wants to know which symbol is best for this trade and which expiration cycle is also best. In order to arrive at a decision, the user would simply click a button and the Trade Assistant™ will create and compare the 2 Iron Condors on the underlying assets and expiration dates chosen by the user and rank them according to the perspective internals set up by the user preferences. Finally, if a user wishes to build a trade from the trade models, they simply click a button and the trade is constructed for them no matter how complex it is. So not only does the Trade Assistant™ compare and rank the trade model perspective attributes, but it also makes building trades very simple. In traditional software a user typically builds trades from an option chain. The Trade Assistant™ allows the user to bypass the option chain to construct a trade, and the trade is fully analyzed before it's built as well. If the user doesn't like the analysis, then the user doesn't need to build the trade. Traditionally a user will build a trade first and then analyze it after which can waste a lot of time.

Other Outputs (Graphs)

Another feature of perspective output is to apply this technology to a charting interface to visually see the option attributes in 3D. For example, we can graph perspective volatility, perspective Delta, perspective Theta, etc. The user can compare graphs of volatility based on value compared to volatility based on perspective. The user will see the graphs are different. We can also output this information on single option contracts as well as the relationships of the perspective information. All of the perspective formulas which we have previously mentioned, can be graph to show their historical data points.

One embodiment is to graph the perspective attributes on the Y axis and use the Delta on the X axis. This is a way to eliminate the effects the volatility smile has on the chart when the underlying strike price is put on the X axis. One use of this is to plot the perspective volatility on the Y axis and the Delta on the X. This embodiment provides a user with yet another perspective of volatility.

Live Positions and Adjustments

The Trade Assistant™ can also be used to monitor live positions as shown in FIGS. 9 and 10. Since the user can configure the output and input data settings, the Trade Assistant™ can help the user to understand why a live position is behaving the way it is. The user will be able to see why the Greeks are changing and why the profit and loss is changing. The user will also be able to see when the trade is most likely to make or lose money, so the technology can help the user manage their positions. The Trade Assistant™ can show a trader when the probabilities are in their favor or no longer in their favor. Thus, it can help them maximize profits by showing the user when to enter and to exit their trades. Also, the Trade Assistant™ can assist the user in making the best adjustment decisions during a trade by changing existing perspective attributes to a more favorable perspective position. For example, let's say a trader is in a live position and it has a poor perspective volatility skew rating and the color is red. Then, the user combines their live trade with a trade model and the new, combined output for the perspective volatility skew is now improved, so the output color changes to green. Like this the user has found an adjustment that will improve the perspective internals of a trade.

Generic Computing Device

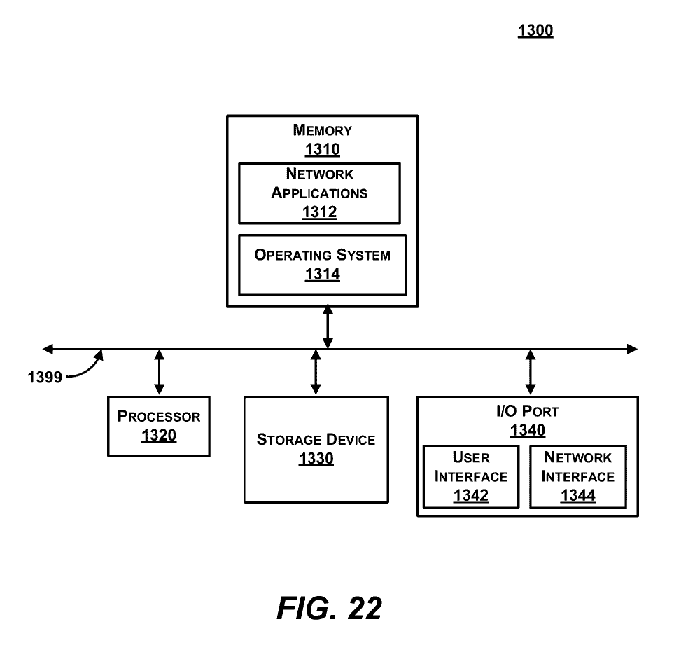

FIG. 22 is a block diagram illustrating an exemplary computing device 2200 for use in the system 100 of FIG. 10, according to one embodiment. The computing device 1300 is an exemplary device that is implementable for each of the components of the system 1000, including the perspective output server 1010, the stock and options history database 1020 and the user device 1030. Additionally, the computing device 1300 is merely an example implementation itself, since the system 1000 can also be fully or partially implemented with laptop computers, tablet computers, smart cell phones, Internet appliances, and the like.

The computing device 2200, of the present embodiment, includes a memory 2210, a processor 2220, a hard drive 2230, and an I/O port 2240. Each of the components is coupled for electronic communication via a bus 2299. Communication can be digital and/or analog, and use any suitable protocol.

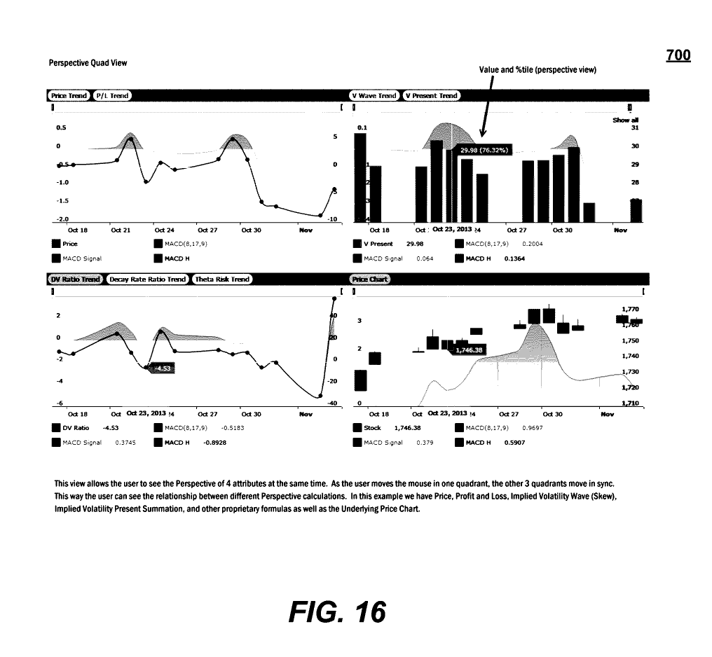

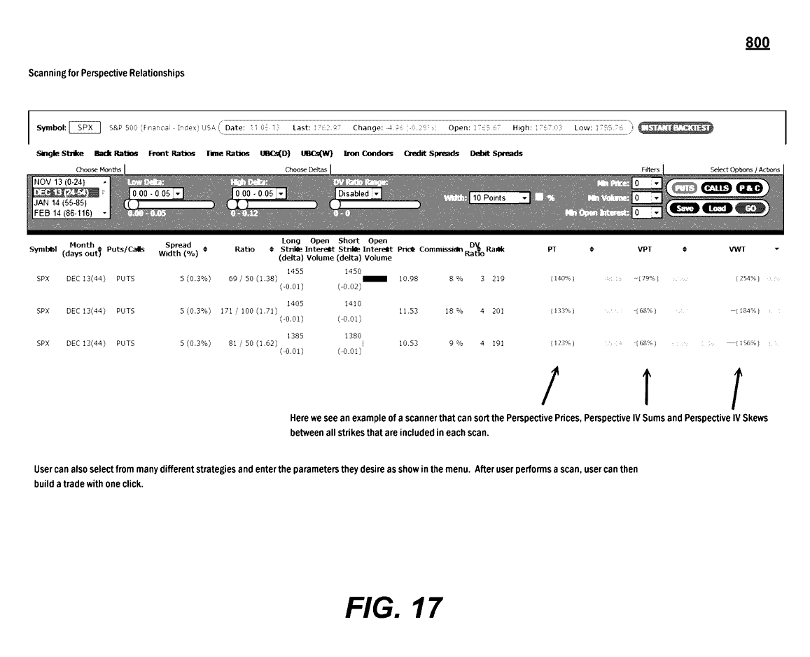

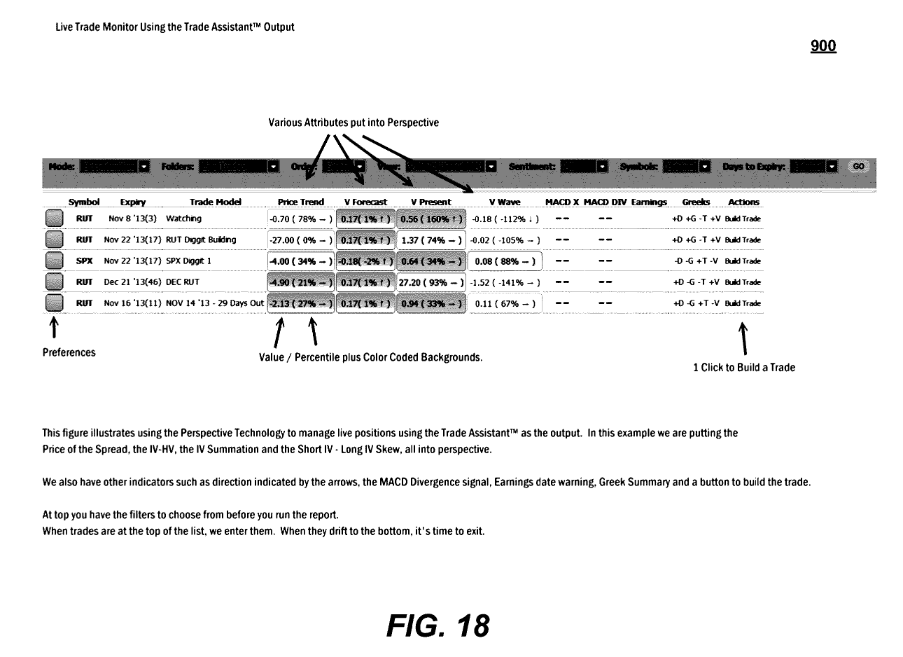

The memory 2210 further comprises network applications 2212 and an operating system 2214. The network applications 2220 can include the modules of network applications or APs as illustrated in FIGS. 22 and 16. Other network applications can include 2212 a web browser, a mobile application, an application that uses networking, a remote application executing locally, a network protocol application, a network management application, a network routing application, or the like.

The operating system 2214 can be one of the Microsoft Windows® family of operating systems (e.g., Windows 913, 98, Me, Windows NT, Windows 2000, Windows XP, Windows XP x134 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX134. Other operating systems may be used. Microsoft Windows is a trademark of Microsoft Corporation.

The processor 2220 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 2220 can be single core, multiple core, or include more than one processing elements. The processor 2220 can be disposed on silicon or any other suitable material. The processor 2220 can receive and execute instructions and data stored in the memory 2210 or the hard drive 2230.

The storage device 2230 can be any non-volatile type of storage such as a magnetic disc, EEPROM, Flash, or the like. The storage device 2230 stores code and data for applications.

The I/O port 2240 further comprises a user interface 2242 and a network interface 2244. The user interface 2242 can output to a display device and receive input from, for example, a keyboard. The network interface 1444 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method for back-testing strategies over customizable preset date ranges in an options portfolio, the method comprising:
configuring a set of back tests, comprising:
identifying one or more assets in an options portfolio as received from a user;
assigning a trade configuration for each of the back tests as received from the user; and
selecting a date range received for each of the set of back tests as received from the user;
obtaining options data including a historical price chart for the one or more assets in the options portfolio, each historical price chart comprising real price data in accordance with the date range;
generating P&L (profit and loss) graphs including a P&L graph for each back test showing an amount of profit or loss over the date range configured by applying the trade configuration for the one or more assets to the historical price chart; and
displaying the P&L graph corresponding to each of the back tests for the options portfolio.
